(19) United States
(12) Patent Application Publication
(10) Pub. No.: US 2024/0326372 A1
(43) Pub. Date: Oct. 3, 2024

(54) PREPREGS AND CURED COMPOSITES HAVING IMPROVED SURFACES AND PROCESSES OF MAKING AND METHODS OF USING SAME

(71) Applicant: Government of the United States as represented by the Secretary of the Air Force, Wright-Patterson AFB, OH (US)

(72) Inventors: Adam S. Hicks, Huber Heights, OH (US); Jared W. Speltz, Washington Township, OH (US); Andrea K. Helbach, Dayton, OH (US); Kara M. Storage, Beavercreek, OH (US); Tara M. Storage, Beavercreek, OH (US); Michael Anthony Pratt, JR., Dayton, OH (US)

(21) Appl. No.: 18/740,641

(22) Filed: Jun. 12, 2024

Related U.S. Application Data
(63) Continuation of application No. 17/681,949, filed on Feb. 28, 2022.
(60) Provisional application No. 63/155,015, filed on Mar. 1, 2021.

(51) Int. Cl. B32B 3/26; B23K 26/0622; B23K 26/352; B23K 26/402; B32B 5/02; B32B 7/12; B32B 27/12

(52) U.S. Cl. CPC B32B 3/266; B23K 26/0624; B23K 26/402; B32B 5/024; B32B 7/12; B32B 27/12; B23K 26/3584; B32B 2262/103; B32B 2262/106; B32B 2307/202

(57) ABSTRACT

The present invention discloses cured composites having improved surfaces and processes of making and methods of using same. Such processes use ultra-short pulse lasers, for example, a femto-second laser to ablate material without the detrimental heat affected zones of other laser processes. Such process can not only increases surface roughness and clean contaminates, but can also selectively remove the matrix material and expose the surface fibers of cured composites. The treated cured composites have improved thermal and electrical pathways that can dissipate unwanted heat and electricity when two or more prepregs and/or cured composites are bonded or cured to form a single article.

### CROSS-REFERENCE TO RELATED APPLICATION

The present application is a continuation of and claims priority to U.S. application Ser. No. 17/681,949 filed Feb. 28, 2022, which in turn claims priority to U.S. Provisional Application Ser. No. 63/155,015 filed Mar. 1, 2021, the contents of both such applications being hereby incorporated by reference in their entry.

### RIGHTS OF THE GOVERNMENT

The invention described herein may be manufactured and used by or for the Government of the United States for all governmental purposes without the payment of any royalty.

### FIELD OF THE INVENTION

The present invention relates to prepregs and cured composites having improved surfaces and processes of making and methods of using same.

### BACKGROUND OF THE INVENTION

Polymer matrix composite (PMC) surface preparation is used to increase bond strength in composite bonding applications. Current methods, such as sanding and plasma cleaning, are used to reduce foreign contaminates to increase surface roughness of cured composite surfaces. These processes are time consuming and labor intensive. Sanding, which is current best practice for many bonding applications, produces an undesirable waste stream, accounts for expensive touch labor hours, and introduces a level of operator variability that is unacceptable for some bonding applications. Peel-ply layers are commonly included in the composite manufacturing process in order to induce a rough the texture of the surfaces of the cured composite. Unfortunately, applying and removing peel ply and manual sanding are labor intensive, produce an undesirable waste stream, and are too uncontrolled enough for most aerospace applications.

As a result of such drawbacks, industry has attempted laser ablation to prepare cured composite surfaces. Unfortunately, current common laser ablation processes give rise to detrimental heat affected zones not only on the surfaces of cured composites but also on the underlying fiber layers. Such, heat zones result in damaged resin and fiber areas that weaken the overall structure and gives rise to contaminates that inhibit optimal surface area bonding.

Applicant recognized that the source of such laser ablation problem was the excessive pulse duration of the laser, which inhibits the coulomb explosion needed to perform athermal ablation. Based on such recognition, Applicants' developed a process that uses ultra-short pulse lasers, for example, a Femto-second (fs) laser to ablate material without the detrimental heat affected zones of other laser processes. Applicants' process not only increases surface roughness and cleans contaminates, but can also selectively remove the matrix material and expose the surface fibers of prepregs and cured composites. By exposing the surface fibers, through-bond thermal conductivity and surface electrical conductivity is also increased. Thus, the treated prepregs and cured composites have improved thermal and electrical pathways that can dissipate unwanted heat and electricity when two or more prepregs and composites are bonded or cured to form a single article.

### SUMMARY OF THE INVENTION

The present invention discloses cured composites having improved surfaces and processes of making and methods of using same. Such processes use ultra-short pulse lasers, for example, a Femto-second laser to ablate material without the detrimental heat affected zones of other laser processes. Such process not only increases surface roughness and cleans contaminates, but can also selectively remove the matrix material and expose the surface fibers of cured composites. The treated cured composites have improved thermal and electrical pathways that can dissipate unwanted heat and electricity when two or more composites are bonded or cured to form a single article.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a side view of a composite structure.

FIG. 2 is a top view of the composite structure referenced in FIG. 1. Circular areas of the top resin layer have been laser ablated away, exposing the subsurface fiber layer.

FIG. 3 is an isometric view of FIG. 2, denoting that some depth of resin has been removed, while leaving the fiber layer with minimal or no damage.

FIG. 4 shows two composite structures bonded together, thus mating their laser processed surfaces. This allows for the necessary electrical conductivity pathways from one composite structure to the other.

FIG. 5A depicts a sateen fiber weave fiber architecture used in the present PMC manufacturing.

FIG. 5B depicts a unidirectional fiber tape fiber architecture used in the present PMC manufacturing.

FIG. 6A represents an example processing state for each of the fiber architectures shown in FIGS. 5A and 5B. After the top most resin is removed from the composite, the peaks of the sateen are exposed.

FIG. 6B represents an example processing state for each of the fiber architectures shown in FIG. 5B. After the top most resin is removed from the composite, the tops of individual fibers are exposed.

FIG. 7A represents a process state with even more resin removed than that of FIG. 6A. Greater fabric peaks area are exposed for the sateen weave, thus exposing more fiber surface area fraction.

FIG. 7B represents a process state with even more resin removed than that of FIG. 6B. Even more of the fiber strands are exposed, thus exposing more fiber surface area fraction.

FIG. 8 is drawing of the developed test methodology to test through-bond conductivity for co-bonded composite structure specimens. This will measure the cumulative conductivity of the interlaminate and adhesive pathways or resultant, bonded composite structure.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about,” “approximately,” or the like, when accompanying a numerical value, are to be construed as indicating a deviation as would be appreciated by one of ordinary skill in the art to operate satisfactorily for an intended purpose.

As used herein, the words “and/or” means, when referring to embodiments (for example an embodiment having elements A and/or B) that the embodiment may have element A alone, element B alone, or elements A and B taken together.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

As used in this specification, the term “prepreg” means a fibrous material that is impregnated with a synthetic and/or natural resin.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Composite Structures and Articles

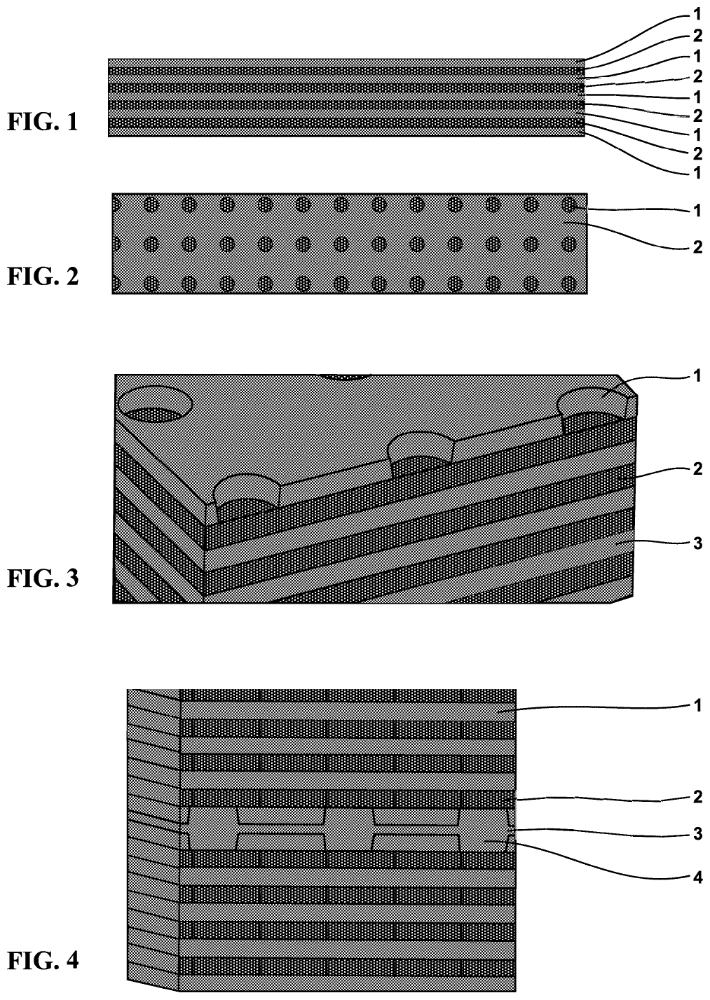

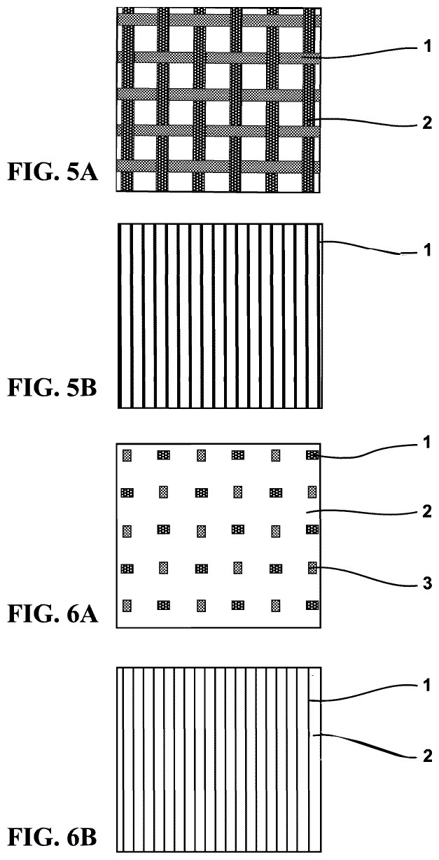

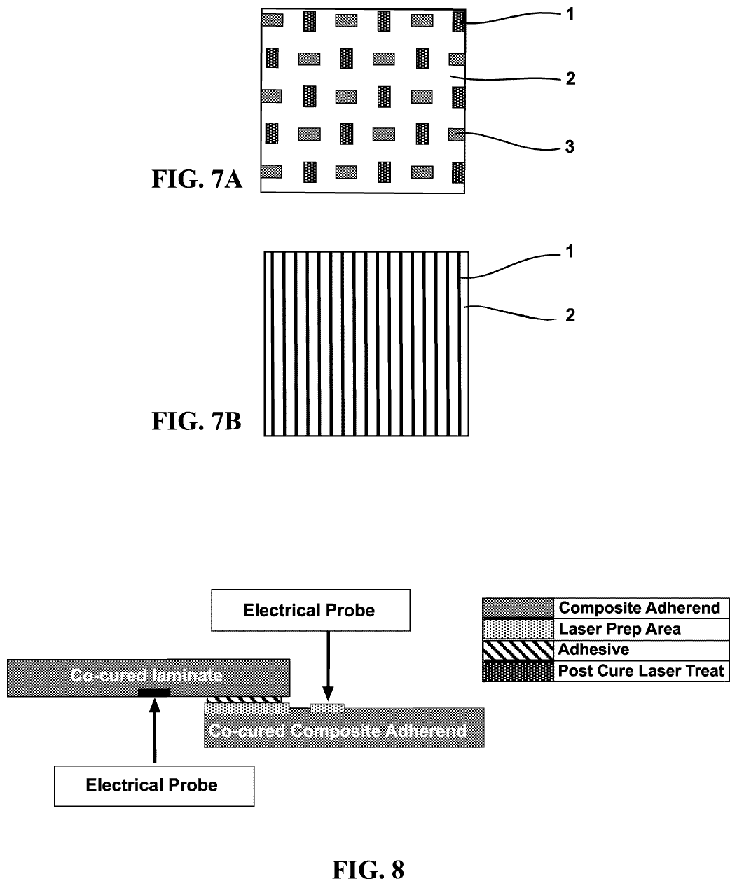

For purposes of this specification, headings are not considered paragraphs and thus this paragraph is paragraph thirty of the present specification. The individual number of each paragraph above and below this paragraph can be determined by reference to this paragraph's number. In this paragraph thirty Applicants disclose a composite structure comprising:
a) a fibrous material said fibrous material comprising fibers selected from the group consisting of carbon fibers, metallic fibers, and mixtures thereof; and
b) a cured resin system comprising a resin selected from the group consisting of epoxy resin, bismaleimide resin, polyimide resin, cyanate ester resin, and mixtures thereof,
   said composite structure comprising at least one ablated surface area having a total surface electrical conductivity of about 1% to about 100% of the neat fibrous material from which it is constructed, preferably said composite having a total surface electrical conductivity of about 50% to about 100% of the neat fibrous material from which it is constructed, more preferably said composite having a total surface electrical conductivity of about 75% to about 100% of the neat fibrous material from which it is constructed, most preferably said composite having a total surface electrical conductivity of about 90% to about 100% of the neat fibrous material from which it is constructed and/or said composite structure comprising at least one ablated surface area having a surface consisting of exposed surface fiber area fraction of about 1% to about 100%, preferably said composite having a surface consisting of exposed surface fiber area fraction of about 50% to about 100%, more preferably said composite having a surface consisting of exposed surface fiber area fraction of about 75% to about 100%, most preferably said composite having a surface consisting of exposed surface fiber area fraction of about 90% to about 100%. In one aspect, the upper ranges of the total surface electrical conductivity and exposed surface fiber area fraction ranges provided above maybe 99% or even 99.9%. The ablated region need not have any particular shape nor must the ablated area have any particular geometric shape(s) within the ablated region. Instead of performance being ablated region shape dependent, the present invention's performance depends on the amount of fibrous material that is exposed by the ablation process. Thus, the composite structure's total surface electrical conductivity and exposed surface fiber area fraction are linked because as the percentage of exposed surface fiber area fraction increases total surface electrical conductivity increases. FIGS. 1-3 and 5-7 show examples of composite structure starting material before and after ablation. Specifically, FIG. 1 is a side view of a composite structure before ablation showing 1 resin/polymer rich areas between fiber plies in an exemplar Polymer Matrix Composite (PMC) stack-up and 2 fiber layers in an exemplar Polymer Matrix Composite (PMC) stack-up. FIG. 2 is a top view of the composite structure referenced in FIG. 1. Circular areas 1 of the top resin layer 2 have been laser ablated away, exposing the subsurface fiber layer. FIG. 3 is an isometric view of FIG. 2, denoting that some depth of resin has been removed, while leaving the fiber layer with minimal or no damage. FIG. 3 shows 1 one of a multitude of an example of a fully laser processed circular areas, which removes the topmost resin/polymer layers and exposes the first subsurface fiber layer, 2 one of a multitude of example fiber layer in an exemplar Polymer Matrix Composite (PMC) stack-up and 3 one of a multitude of example resin/polymer rich areas between fiber plies in an exemplar Polymer Matrix Composite (PMC) stack-up. FIG. 5A depicts a sateen fiber weave fiber architecture used in the present PMC manufacturing and shows 1 which is one of a multitude of 0° fiber tows in such example sateen woven fiber layer and 2 which is one of a multitude of 90° fiber tows in such example sateen woven fiber layer. FIG. 5B depicts a unidirectional fiber tape fiber architecture used in the present PMC manufacturing and shows 1 which is one of the multitude of fiber strands in an example unidirectional tape fiber layer. FIG. 6A represents an example processing state for each of the fiber architectures shown in FIGS. 5A and 5B. After the top most resin is removed from the composite, the peaks of the sateen are exposed. FIG. 6A shows 1 which is one of a multitude of 90° fiber tows in such example sateen woven fiber layer after a low level of processing, 2 the remaining surface resin which has not yet been fully removed and 3 which is one of a multitude of 0° fiber tows in such example sateen woven fiber layer after a low level of processing. FIG. 6B represents an example processing state for each of the fiber architectures shown in FIG. 5B. After the top most resin is removed from the composite, the tops of individual fibers are exposed. FIG. 6B shows 1 which is one of a multitude of fiber strands in such example unidirectional tape fiber layer after a low level of processing and 2 which is the remaining surface resin which has not yet been fully removed. FIG. 7A represents a process state with even more resin removed than that of FIG. 6A. Greater fabric peaks area are exposed for the sateen weave, thus exposing more fiber surface area fraction. FIG. 7A shows 1 which is one of a multitude of 90° fiber tows in such example sateen woven fiber layer after a higher level of processing, 2 the remaining surface resin which has not yet been fully removed and 3 which is one of a multitude of 0° fiber tows in an example sateen woven fiber layer after a higher level of processing. FIG. 7B represents a process state with even more resin removed than that of FIG. 6B. Even more of the fiber strands are exposed, thus exposing more fiber surface area fraction. FIG. 7B shows 1 which is one of a multitude of fiber strands in such example unidirectional tape fiber layer after a higher level of processing and 2 which is the remaining surface resin which has not yet been fully removed.

Applicants disclose an article comprising at least two composite structures of paragraph thirty and an electrically conductive adhesive, said electrically conductive adhesive connecting at least one of said composite structure's ablated surface area with at least one ablated surface area of another composite structure of paragraph twenty-eight, said article having a through bond electrical conductivity of about 1% to about 100% of the neat fibrous material and/or the neat electrically conductive adhesive, preferably said article having a surface electrical conductivity of about 50% to about 100% of the neat fibrous material and/or the neat electrically conductive adhesive, more preferably said composite having a surface electrical conductivity of about 75% to about 100% of the neat fibrous material and/or the neat electrically conductive adhesive, most preferably said composite having a surface electrical conductivity of about 90% to about 100% of the neat fibrous material and/or the neat electrically conductive adhesive. In one aspect, the upper ranges of the through bond electrical conductivity ranges provided above maybe 99% or even 99.9%. FIG. 4 shows two composite structures bonded together, thus mating their laser processed surfaces and shows 1 which is one of a multitude of example resin/polymer rich areas between fiber plies in an exemplar Polymer Matrix Composite (PMC) stack-up, 2 which is one of a multitude of example fiber layer in an exemplar Polymer Matrix Composite (PMC) stack-up, 3 which is an electrically conductive adhesive layer used to bond multiple processed composites together and 4 which is a side view of one of a multitude of composite surface circular laser processed areas. This allows for the necessary electrical conductivity pathways from one composite structure to the other.

Applicants disclose an article according to paragraph thirty-one comprising two to 1000 composite structures according to paragraph thirty, two to 100 composite structures of according to paragraph thirty or two to 10 composite structures of according to paragraph thirty, each of said composite structures' ablated surface areas being bonded by said electrically conductive adhesive to at least one ablated surface area of another of said composite structures according to paragraph thirty.

Applicants disclose an article according to paragraphs thirty-one to thirty-two wherein said electrically conductive adhesive comprises carbon and/or metallic particles and a resin system selected from the group consisting of an epoxy resin, a bismaleimide resin, a polyimide resin, a cyanate ester resin, and mixtures thereof.

### Process of Making Composite Structures

For purposes of this specification, this paragraph is paragraph thirty-four. Applicants disclose, in this paragraph a process of making a composite structure having a surface, said process comprising laser ablating at least a portion of said surface of said composite using a laser having a pulse length of from about 1 attosecond to about 100 picoseconds, preferably said laser having a pulse length of from about 1 femtosecond to about 10 picosecond, more preferably said laser having a pulse length of from about 1 femtosecond to about 1 picosecond, most preferably said laser having a pulse length of about 1 femtosecond to about 500 femtoseconds; a fibrous material said fibrous material comprising fibers selected consisting of carbon fibers, metallic fibers and mixtures thereof; and a cured resin system comprising a resin selected consisting of epoxy resin, bismaleimide resin, polyimide resin, cyanate ester resin, and mixtures thereof. In one aspect, the laser used to conduct this process has a laser power average that is greater than or equal to 5 Watts at repetition rate of 500 KHz.

Applicants disclose the process of paragraph thirty-four, wherein from about 0.1 percent to about 100 percent of said composite's surface is ablated, in one aspect, from about 1 percent to about 40 percent of said composite's surface is ablated, in one aspect, from about 1 percent to about 10 percent of said composite's surface is ablated, in one aspect, from about 1 percent to about 5 percent of said composite's surface is ablated.

Applicants disclose the process of paragraph thirty-four through thirty-five wherein said surface of said composite structure is ablated to yield a composite structure comprising at least one ablated surface area having a total surface electrical conductivity of about 1% to about 100% of the neat fibrous material from which it is constructed, preferably said composite having a total surface electrical conductivity of about 50% to about 100% of the neat fibrous material from which it is constructed, more preferably said composite having a total surface electrical conductivity of about 75% to about 100% of the neat fibrous material from which it is constructed, most preferably said composite having a total surface electrical conductivity of about 90% to about 100% of the neat fibrous material from which it is constructed and/or said composite structure comprising at least one ablated surface area having a surface consisting of exposed surface fiber area fraction of about 1% to about 100%, preferably said composite having a surface consisting of exposed surface fiber area fraction of about 50% to about 100%, more preferably said composite having a surface consisting of exposed surface fiber area fraction of about 75% to about 100%, most preferably said composite having a surface consisting of exposed surface fiber area fraction of about 90% to about 100%. In one aspect, the upper ranges of the total surface electrical conductivity and exposed surface fiber area fraction ranges provided above maybe 99% or even 99.9%.

### Test Methods

### In-Plane Electrical Conductivity Test

The CLASP induced electrical conductivity is determined as follows using a 75 mm by 75 mm sample of material to be tested:
1.) Utilizing a Digital Multi-meter with two hardpoint leads, set it to measure resistance;
2.) Set both probes in an unprocessed area of the PMC panel. This step verifies the nonconductivity of the unprocessed area.
3.) Set one probe in a processed area with exposed fiber, and the 2^{nd} probe in a non-processed area, verify the measured conductivity is less than 1% of the conductivity of the fiber of which the composite is comprised. This step verifies the nonconductivity of the unprocessed area.
4.) Set one probe in a processed area with exposed fiber, and set the 2^{nd} probe in another processed area with exposed fiber approximately 25 mm away and verify conductivity is greater than or equal to 1% of the conductivity of the fiber of which the composite is comprised. The value obtained from this step is the electrical conductivity value for the measured processed points in the processed area. Repeat the measurement in this step eight additional times in evenly spaced interval across the samples area.
5.) For purposes of the present invention, the total surface electrical conductivity of the test sample is an average of the nine measurements from Step 4.

### Exposed Fiber Area Fraction Test

The CLASP induced exposed surface fiber area fraction is determined as follows using a 75 mm by 75 mm sample of material to be tested:
1.) During the laser processing, a CMOS camera having a 1 over 1.7 inch sensor format and a 12 mega pixel resolution is used to capture the entire processing field of the 75 mm by 75 mm sample of material to be tested. This CMOS camera must be fitted with a 8.5 mm fixed focal lense to rectify the field of view and a short wave filter tuned to ±2 nm of the emission spectrum of the underlying fiber layers with a narrow enough wavelength band to differentiate the fiber from the resin.
2.) During the laser processing, images are collected at a repetition rate of one frame per second over the laser processing time utilizing long exposure image capturing. The images are then compiled together using Image J software Version 1.53o to form a single intensity image, which is converted into a binary data set to determine the percent surface area, exposed fiber.

### Through Bond Electrical Conductivity Test as Depicted in FIG. 8

The CLASP induced through plane electrical conductivity is determined as follows using a 75 mm by 75 mm sample of material to be tested:
1.) Utilizing a Digital Multi-meter with two hardpoint leads, set it to measure resistance;
2.) Set one probe in an unprocessed area of the upper panel of the bonded panels, set the second probe in an unprocessed area of the lower panel of the bonded panels, and verify the measured conductivity is less than 1% of the conductivity of the fiber of which the composite is comprised.
3.) Set one probe in the processed area of the upper panel of the bonded panels, set the second probe in an unprocessed area of the lower panel of the bonded panels, verify non-conductivity.
4.) Set one probe in the processed area of the upper panel of the bonded panels, set the second probe in the processed area of the lower panel of the bonded panels, verify conductivity is greater than or equal to 1% of the conductivity of the fiber and/or adhesive of which the composite is comprised. The value obtained from this step is the electrical conductivity value for the measured processed points in the processed area. Repeat the measurement in this step eight additional times in evenly spaced intervals across the samples area.
5.) For purposes of the present invention, the through bond electrical conductivity of the test sample is an average of the nine measurements from Step 4.

### Characterization of Processed Composite Structure

Optical microscope images are used to evaluate the quality of ultrafast laser inscribed structures. Microscopic images can provide estimates of the quality by looking at the laser-modified structures in processed areas. The modified structure geometry and relative modification can be observed.

Confocal microscopy images are used to evaluate the quality of ultrafast laser inscribed structures. Confocal images can provide estimates of the quality by looking at the laser-modified structures in processed areas. The modified structure geometry and relative modification can be observed for fiber exposure and damage as well as matrix heat affected zones.

Surface energy measurements are taken with a BTG surface analyst to observe effects of the laser processed areas.

Wipe test of the processed area are used to verify lack of debris after laser processing. Indications of surface contamination and proper laser effected surfaces can be observed.

### EXAMPLES

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

### Sample Preparation and Alignment for Composite Structure Processing

### Process Area Preparation for Composite Structure Processing

Processing areas are prepared by first removing the peel-ply from the surface of the composite. Samples are visually inspected for any remaining debris prior to processing. Surface flatness should be no greater than a curvature of 150 mm radius over a 110 mm scan field.

### Process Area Alignment for Composite Structure Process

The galvanometer assembly is placed onto the prepared process area. Displacement sensors measure the offset distance of the focusing optics to the surface and ensure that the area is within the accepted processing focal ranges. An optical camera displays the prepared surface and allows for visual alignment to the desired area for processing.

### Process Field Adjustment

Processing areas that encounter boundary conditions will require modifications to the processing field size and shape. The galvanometer control software allows for adjustments to both the size and shape of the field that will be processed, while still utilizing the alignment methods previously described.

### Example 1: Electrically Connected Secondarily Bonded Composite Structures with Selective Small Circular Area Processing

Two cured composite panels, consisting of IM7 fiber and 5320-1 resin, were prepared as described above. The processing laser utilized was a femto-second laser with a pulse width of 400 fs, repetition rate of 500 KHz and average power of 7 W at the work piece. The laser was focused through a 2-axis galvanometer scanhead by use of a 167 mm F-Theta lens. The attainable focal spot size inside of the material was approximately ˜50 μm. The laser was utilized to process circular areas into the surface of the composites in an 8×8 mm unit cell arrays. The circular structures were designed to achieve 5% surface area coverage. A pre-cured PMC composite substrate was exposed to the laser pulses from the ytterbium fiber laser, while the laser was rastered using the galvanometer scanhead at 2000 mm/s with ˜5 um center to center line spacing. After the circular areas were processed, a secondary laser cleaning processed was used to clear contaminate from the surface. This cleaning pass consists of moving focusing the laser to a 0.5 mm spot and processing the entire 25 mm bond area at 5000 mm/s and ˜50 um center to center line spacing with in average power of 7 W. After the cleaning process, the composites are measured with a touch probe multi-meter between the furthest processed areas and resistance is measured. The composites were then bonded together using a conductive adhesive in order to achieve through bond conductivity. Once the adhesive is applied, the bonded composites are then vacuum bag, oven-cured, out-of-autoclave.

### Example 2: Electrically Connected Co-Bonded Composite Structures with Selective Small Circular Area Processing

One cured composite panel is prepared as described above and then selective areas are processed into the surface. The laser utilized is a femto-second laser with a pulse width of 400 fs, repetition rate of 500 KHz and average power of 7 W at the work piece. The laser is focused through a 2-axis galvanometer scanhead by use of a 167 mm F-Theta lens. The attainable focal spot size inside of the material is approximately ˜50 μm. The laser was utilized to process circular areas into the surface of the composites in an 8×8 mm unit cell arrays. The circular structures were designed to achieve 5% surface area coverage. A pre-cured PMC composite substrate was exposed to the laser pulses from the ytterbium fiber laser, while the laser was rastered using the galvanometer scanhead at 2000 mm/s with ˜5 um center to center line spacing. After the circular areas were processed, a secondary laser cleaning processed was used to clear contaminate from the surface. This cleaning pass consists of moving focusing the laser to a 0.5 mm spot and processing the entire 25 mm bond area at 5000 mm/s and ˜50 um center to center line spacing with in average power of 7 W. After the cleaning process, the composite was co-bonded to an uncured prepreg laminate using conductive adhesive. Once the adhesive is applied, the composite laminates, one cured and one uncured, are then vacuum bag, oven-cured, out-of-autoclave.

### Example 3: Joining Electrically Connected Metallic Components with Selective Small Circular Area Processing

One cured composite panel is prepared as described above and then selective areas are processed into the surface. These areas are targeted to correspond to the specific pad size of metallic joints which are required to be bonded to the exterior of the composite. The laser utilized is a femto-second laser with a pulse width of 400 fs, repetition rate of 500 KHz and average power of 7 W at the work piece. The laser is focused through a 2-axis galvanometer scanhead by use of a 167 mm F-Theta lens. The attainable focal spot size inside of the material is approximately ˜50 μm A pre-cured PMC composite substrate was exposed to the laser pulses from the ytterbium fiber laser, while the laser was rastered using the galvanometer scanhead at 2000 mm/s with ˜5 um center-to-center line spacing. After the circular areas were processed, a secondary laser cleaning processed was used to clear contaminate from the surface. This cleaning pass consists of moving focusing the laser to a 0.5 mm spot and processing the entire 25 mm bond area at 5000 mm/s and ˜50 um center-to-center line spacing with in average power of 7 W. After the cleaning process, the composite was bonded to a metallic surface.

### Example 4: Electrically Connected Secondarily Bonded Composite Structures Using Whole Area Processing

Two cured composite panels, consisting of IM7 fiber and 5320-1 resin, were prepared as described above. The processing laser utilized was a femto-second laser with a pulse width of 400 fs, repetition rate of 500 KHz and average power of 15 W at the work piece. The laser was focused through a 2-axis galvanometer scanhead by use of a 167 mm F-Theta lens. The attainable focal spot size inside of the material was approximately ˜50 μm. A pre-cured PMC composite substrate was exposed to the laser pulses from the ytterbium fiber laser, while the laser was rastered using the galvanometer scanhead at 3800 mm/s with ˜17 um center to center line spacing over the entire processing area. As the laser processed the surface, a CMOS camera, tuned to specifically look at emission spectra of the underlying fiber, gathered data over the entire processing surface. The laser ablation process was repeated until the CMOS determined surface area fiber fraction is over 90%. The composites were then bonded together using a conductive adhesive in order to achieve through bond conductivity. Once the adhesive is applied, the bonded composites are then vacuum bag, oven-cured, out-of-autoclave.

### Example 5: Electrically Connected Co-Bonded Composite Structures Using Whole Area Processing

One cured composite panels, consisting of IM7 fiber and 5320-1 resin, are prepared as described above. The processing laser utilized is a femto-second laser with a pulse width of 400 fs, repetition rate of 500 KHz and average power of 15 W at the work piece. The laser is focused through a 2-axis galvanometer scanhead by use of a 167 mm F-Theta lens. The attainable focal spot size inside of the material is approximately ˜50 μm. A pre-cured PMC composite substrate is exposed to the laser pulses from the ytterbium fiber laser, while the laser is rastered using the galvanometer scanhead at 3800 mm/s with ˜17 um center to center line spacing over the entire processing area. As the laser processed the surface, a CMOS camera, tuned to specifically look at emission spectra of the underlying fiber, gathers data over the entire processing surface. The laser ablation process is then repeated until the CMOS determines surface area fiber fraction is over 90%. The composites are then bonded together using a conductive adhesive in order to achieve through bond conductivity. After the laser processing is complete, the composite is co-bonded to an uncured prepreg laminate using conductive adhesive. Once the adhesive is applied, the composite laminates, one cured and one un-cured, are then vacuum bag, oven-cured, out-of-autoclave.

### Example 6: Joining Electrically Connected Metallic Components. Using Whole Area Processing

One cured composite panels, consisting of IM7 fiber and 5320-1 resin, are prepared as described above. The processing laser utilized is a femto-second laser with a pulse width of 400 fs, repetition rate of 500 KHz and average power of 15 W at the work piece. The laser is focused through a 2-axis galvanometer scanhead by use of a 167 mm F-Theta lens. The attainable focal spot size inside of the material is approximately ˜50 μm. A pre-cured PMC composite substrate is exposed to the laser pulses from the ytterbium fiber laser, while the laser is rastered using the galvanometer scanhead at 3800 mm/s with ˜17 um center to center line spacing over the entire processing area. As the laser processed the surface, a CMOS camera, tuned to specifically look at emission spectra of the underlying fiber, gathers data over the entire processing surface. The laser ablation process is then repeated until the CMOS camera determines surface area fiber fraction is over 90%. The composites are then bonded together using a conductive adhesive in order to achieve through bond conductivity. After the cleaning process, the composite was bonded to a metallic surface.

Every document cited herein, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A composite structure comprising:
a) a fibrous material said fibrous material comprising fibers selected from the group consisting of carbon fibers, metallic fibers, and mixtures thereof; and
b) a cured resin system comprising a resin selected from the group consisting of epoxy resin, bismaleimide resin, polyimide resin, cyanate ester resin, and mixtures thereof,
said composite structure comprising at least one ablated surface area having a total surface electrical conductivity of about 1% to about 100% of the neat fibrous material from which it is constructed, and/or said composite structure comprising at least one ablated surface area having a surface consisting of exposed surface fiber area fraction of about 1% to about 100%.

2. The composite structure of claim 1 said composite structure comprising at least one ablated surface area having a total surface electrical conductivity of about 50% to about 100% of the neat fibrous material from which it is constructed, and/or said composite structure comprising at least one ablated surface area having a surface consisting of exposed surface fiber area fraction of about 50% to about 100%.

3. The composite structure of claim 1 said composite structure comprising at least one ablated surface area having a total surface electrical conductivity of about 75% to about 100% of the neat fibrous material from which it is constructed and/or said composite structure comprising at least one ablated surface area having a surface consisting of exposed surface fiber area fraction of about 75% to about 100%.

4. The composite structure of claim 1 said composite structure comprising at least one ablated surface area having a total surface electrical conductivity of about 90% to about 100% of the neat fibrous material from which it is constructed and/or said composite structure comprising at least one ablated surface area having a surface consisting of exposed surface fiber area fraction of most preferably said composite having a surface consisting of exposed surface fiber area fraction of about 90% to about 100%.

5. An article comprising at least two composite structures of claim 1 and an electrically conductive adhesive, said electrically conductive adhesive connecting at least one of said composite structure's ablated surface area with at least one ablated surface area of another composite structure of claim 1, said article having a through bond electrical conductivity of about 1% to about 100% of the neat fibrous material and/or the neat electrically conductive adhesive.

6. An article according to claim 5, said article having a surface electrical conductivity of about 50% to about 100% of the neat fibrous material and/or neat electrically conductive adhesive.

7. An article according to claim 5, said article having a surface electrical conductivity of about 75% to about 100% of the neat fibrous material and/or the neat electrically conductive adhesive.

8. An article according to claim 5, said article having a surface electrical conductivity of about 90% to about 100% of the neat fibrous material and/or the neat electrically conductive adhesive.

9. The article according to claim 5 comprising two to 1000 composite structures of claim 1, each of said composite structures' ablated surface areas being bonded by said electrically conductive adhesive to at least one ablated surface area of another of said composite structures of claim 1.

10. The article according to claim 5 comprising two to 10 composite structures of claim 1, each of said composite structures' ablated surface areas being bonded by said electrically conductive adhesive to at least one ablated surface area of another of said composite structures of claim 1.

11. The article according to claim 5 wherein said electrically conductive adhesive comprises carbon and/or metallic particles and a resin system selected from the group consisting of an epoxy resin, a bismaleimide resin, a polyimide resin, a cyanate ester resin, and mixtures thereof.

12. A process of making a composite structure having a surface, said process comprising laser ablating at least a portion of said surface of said composite using a laser having a pulse length of from about 1 attosecond to about 100 picoseconds, said composite structure comprising a fibrous material said fibrous material comprising fibers selected consisting of carbon fibers, metallic fibers and mixtures thereof; and a cured resin system comprising a resin selected consisting of epoxy resin, bismaleimide resin, polyimide resin, cyanate ester resin, and mixtures thereof.

13. A process according to claim 12 of making a composite structure having a surface, said process comprising laser ablating at least a portion of said surface of said composite using a laser having a pulse length of from about 1 femtosecond to about 10 picosecond, said composite structure comprising a fibrous material said fibrous material comprising fibers selected consisting of carbon fibers, metallic fibers and mixtures thereof; and a cured resin system comprising a resin selected consisting of epoxy resin, bismaleimide resin, polyimide resin, cyanate ester resin, and mixtures thereof.

14. A process according to claim 12 of making a composite structure having a surface, said process comprising laser ablating at least a portion of said surface of said composite using a laser having a pulse length of from about 1 femtosecond to about 1 picosecond, said composite structure comprising a fibrous material said fibrous material comprising fibers selected consisting of carbon fibers, metallic fibers and mixtures thereof; and a cured resin system comprising a resin selected consisting of epoxy resin, bismaleimide resin, polyimide resin, cyanate ester resin, and mixtures thereof.

15. A process according to claim 12 of making a composite structure having a surface, said process comprising laser ablating at least a portion of said surface of said composite using a laser having a pulse length of from about 1 femtosecond to about 500 femtoseconds; said composite structure comprising a fibrous material said fibrous material comprising fibers selected consisting of carbon fibers, metallic fibers and mixtures thereof; and a cured resin system comprising a resin selected consisting of epoxy resin, bismaleimide resin, polyimide resin, cyanate ester resin, and mixtures thereof.

16. The process of claim 12, wherein from about 0.1 percent to about 100 percent of said composite's surface is ablated.

17. The process of claim 12, wherein from about 1 percent to about 5 percent of said composite's surface is ablated.

18. The process of claim 12 wherein said surface of said composite structure is ablated to yield a composite structure comprising at least one ablated surface area having a total surface electrical conductivity of about 1% to about 100% of the neat fibrous material from which it is constructed and/or said composite structure comprising at least one ablated surface area having a surface consisting of exposed surface fiber area fraction of about 1% to about 100%.

19. The process of claim 12 wherein said surface of said composite structure is ablated to yield a composite structure comprising at least one ablated surface area having a total surface electrical conductivity of about 50% to about 100% of the neat fibrous material from which it is constructed and/or said composite structure comprising at least one ablated surface area having a surface consisting of exposed surface fiber area fraction of about 50% to about 100%.

20. The process of claim 12 wherein said surface of said composite structure is ablated to yield a composite structure comprising at least one ablated surface area having a total surface electrical conductivity of about 75% to about 100% of the neat fibrous material from which it is constructed and/or said composite structure comprising at least one ablated surface area having a surface consisting of exposed surface fiber area fraction of about 75% to about 100%.

21. The process of claim 12 wherein said surface of said composite structure is ablated to yield a composite structure comprising at least one ablated surface area having a total surface electrical conductivity of about 90% to about 100% of the neat fibrous material from which it is constructed and/or said composite structure comprising at least one ablated surface area having a surface consisting of exposed surface fiber area fraction of most preferably said composite having a surface consisting of exposed surface fiber area fraction of about 90% to about 100%.
